(19) United States
(12) Patent Application Publication
(10) Pub. No.: US 2002/0165990 A1
(43) Pub. Date: Nov. 7, 2002

(54) Method and system for adapting short-range wireless access points for participation in a coordinated networked environment

(75) Inventors: Sandeep K. Singhal, Englewood Cliffs, NJ (US); Rangachari Anand, Teaneck, NJ (US); Ajei S. Gopal, Bronx, NY (US); Richard K. Neves, Tarrytown, NY (US)

Correspondence Address: GLENN GOLD, P.A., Suite 450, 600 North Pine Island Rd., Plantation, FL, 33324, US

(73) Assignee: ReefEdge, Inc., Fort Lee, NJ (US)

(21) Appl. No.: 09/848,662

(22) Filed: May 3, 2001

(51) Int. Cl. G06F 15/16

(52) U.S. Cl. 709/249; 709/246

(57) ABSTRACT

A system and a method for enabling existing short range wireless access points to participate within a coordinated networked environment through the use of adapters that extend the access points' capabilities, implement policies, and perform other operations.

### CROSS REFERENCE TO RELATED APPLICATIONS

This application is co-pending with and claims pursuant to 35 U.S.C. §120 as to its common subject matter the filing date of patent application Ser. No. 09/637,742, filed Aug. 11, 2000, and patent application Ser. No. 09/657,745, filed Sep. 10, 2000.

### BACKGROUND OF THE INVENTION

1. Field of Invention

The invention relates generally to wireless networks, and more particularly to an adapter method for extending stand-alone wireless access points to enable their delivery of an integrated solution within a network environment.

2. Description of the Prior Art

Short-range wireless technologies such as 802.11, Bluetooth, HomeRF, and others are being rapidly deployed to allow mobile devices to connect with existing intra-building wired Local Area Networks (LANs). To enable this connectivity, wireless access points are being developed by various manufacturers. An example of such an access point is the Aironet 340 access point (an 802.11 type access point) manufactured by Cisco Systems, Inc. of San Jose, Calif. Another example is the AXIS 9010 access point (a Bluetooth type access point) manufactured by Axis Corporation of Lund, Sweden.

Traditional wireless access points provide limited functionality, essentially limited to enabling a so-called “hotspot” of connectivity to the LAN. The access point operates by forwarding data packets from the wireless environment to the wired LAN, and vice versa. However, within an environment containing multiple access points, conventional stand-alone access points have several limitations. For example, a stand alone access point: (1) cannot be centrally managed; (2) cannot support layer 3 (IP) roaming with other access points; (3) cannot enforce quality-of-service (QoS) metrics; (4) cannot deliver centralized logging and reporting; and (5) provides only limited security and authentication capability, and no server managed security.

Existing efforts to address the aforementioned limitations involve the incorporation of new infrastructure into an existing network to provide some of the missing services for the access points. One example of this approach is the combination of a Cisco Aironet 350 access point and a Cisco Secure Access Control Server for delivery of authentication and dynamic encryption key generation services. Another example of this approach is the incorporation of a 3Com SuperStack II switch for delivery of authentication and virtual private networking (VPN) access to wireless users. Such conventional approaches have significant drawbacks and limitations. For example, these approaches require one or more of the following: (1) Mandatory software on the client devices (e.g., VPN software); (2) Particular versions of wireless client hardware or firmware, thereby forcing a homogeneous environment; (3) Upgrades to the existing wireless access points; and (4) Complex network configurations, since multiple pieces of infrastructure must be separately installed, configured and managed.

These requirements make deployment difficult, limit device choice, and do not provide a scalable approach to delivering all of the required services for the access points in an enterprise network. Accordingly, there is an established need for a system overcoming the aforementioned drawbacks and limitations of prior art wireless access point systems.

### SUMMARY OF THE INVENTION

It is an object of the present invention to provide a network adapter for an access point within a networked environment.

It is another object of the present invention to provide a network adapter for a plurality of access points within a switched Local Area Network.

In a preferred embodiment of the invention, an adapter device is provided connected to each short-range wireless access point in a network. Each packet transmitted between an access point and the wired LAN passes through the adapter. The adapter may be implemented as a stand-alone Personal Computer (PC), a special-purpose computing appliance, or as a component that physically coupled to the access point, with the component/access point combination encapsulated within a single enclosure.

In one aspect of the invention, the adapter is implemented as a software component or module loaded into the memory of the access point. Preferably, the adapter comprises a wireline network interface, a wireless network interface, an IP stack and network coordination software.

In another aspect of the invention incorporated within a switched LAN environment, a single adapter device can support a plurality of short-range wireless access points.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a block diagram of an adapter connecting wired and wireless networks, in accordance with the present invention;

FIG. 2 is a block diagram of an adapter, in accordance with the present invention;

FIG. 3 is a flow chart illustrating a method for forwarding a packet to a wireless interface, in accordance with the present invention;

FIG. 4 is a flow chart illustrating a method for forwarding a packet to a wire-line interface, in accordance with the present invention;

FIG. 5 is a block diagram of an adapter connected to a plurality of access points through a switch, in accordance with the present invention;

FIG. 6 is a block diagram illustrating three individual access point segments connected to a single adapter, in accordance with the present invention; and

FIG. 7 is a block diagram of an adapter connecting to access points from different wireless networks, in accordance with the present invention.

### DETAILED DESCRIPTION OF THE PREFERRED EMBODIMENT

Generally, a typical network environment consists of a network control server connected to a wired Local Area Network (LAN). The adapter's wireline network interface is connected to the Local Area Network and the adapter's wireless network interface is connected to an access point. The network control server is connected to the Local Area Network, which in turn is connected to the Internet backbone.

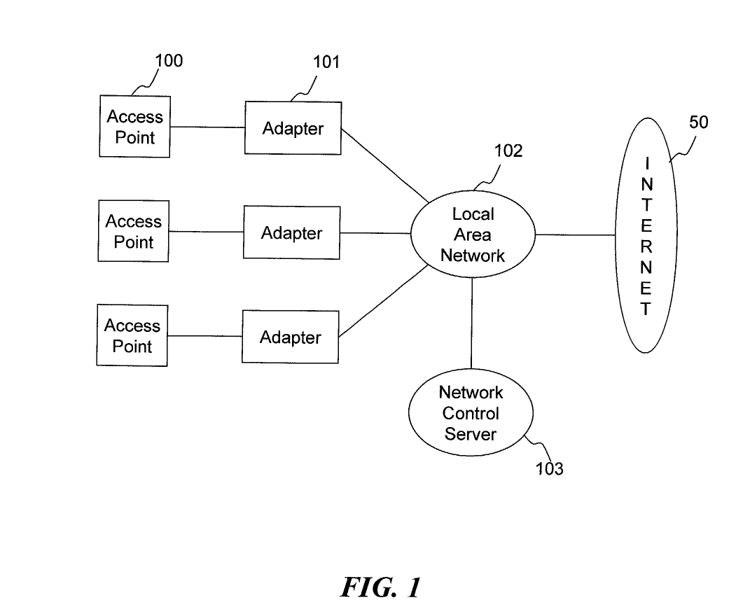

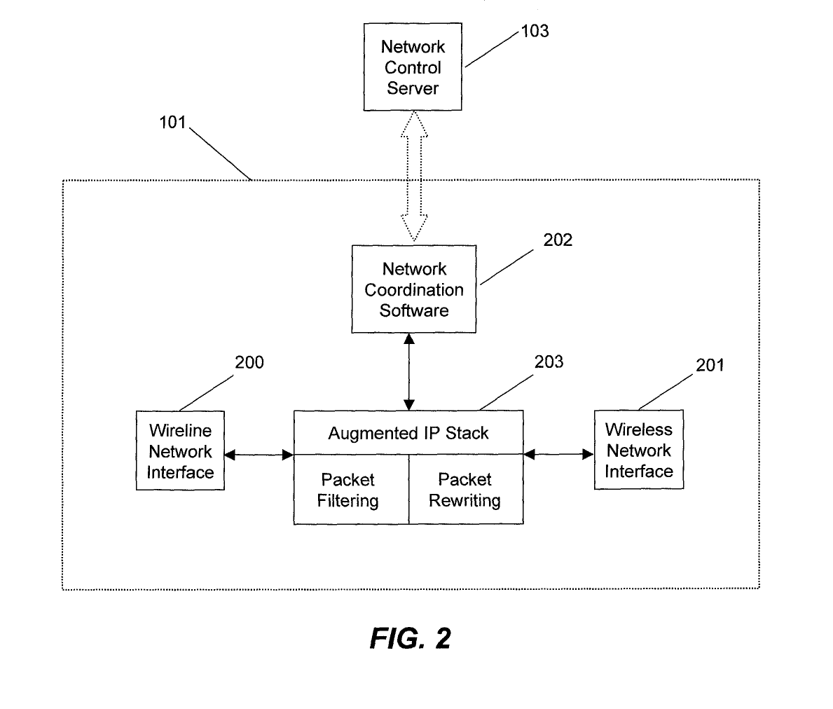

Referring now to FIGS. 1 and 2, one or more adapters 101 are provided connected to corresponding short-range wireless access point 100. In the preferred embodiment of the present invention, adapter 101 has two network interfaces, a wireless network interface and a wireline network interface. The wireless network interface is connected directly to each access point 100, while the wireline network interface is connected directly to a local area network (LAN) 102 or, alternatively, to a switch/router (not shown in FIG. 1). In this manner, all packets sent between access point 100 and the wired LAN 102 must pass through the adapter 101.

The adapters 101 communicate with a Network Control Server (NCS) 103 which maintains information required by the adapters 101 in the networked environment. Preferably, the NCS 103 communicates with the adapters 101 via LAN 102. However, as will be apparent to those skilled in the art, the Network Control Server 103 can be attached directly to each adapter 101, or it can communicate with the adapters via a wide-area network (WAN), such as the Internet.

Adapter 101 can be implemented as a stand-alone personal computer (PC) or, alternatively, as a special-purpose computing appliance. Alternatively, the adapter 101 can be implemented as a component physically coupled to the access point 100, with the combination encapsulated within a single enclosure. In further aspects of the invention, the adapter 101 is implemented as a software component or module loaded into the memory of access point 100.

In an alternative embodiment of the present invention, adapter 101 functions with an existing wired LAN 102 port, instead of a short-range wireless access point 100. In this case, the adapter 101 is attached to a LAN port, and a client device or switch can be attached to the adapter's wireless network interface 201.

Commonly-owned pending U.S. patent application Ser. No. 09/637,742, filed Aug. 11, 2000, and incorporated herein by reference, discloses a wireless networking system wherein a central core server resides in the network infrastructure and provides services to Handoff Management Points (HMPs) as users of devices roam through the environment. The system of the present invention can be implemented in combination with the above-identified related invention, wherein the network control server 103 is co-located with the core server or, alternatively, where the network adapters 101 are co-located with the HMPs. This combined configuration enables clients to travel seamlessly between access points that do not directly support coordination through the core server.

Commonly-owned pending U.S. patent application Ser. No. 09/657,745, filed Sep. 10, 2000, and incorporated herein by reference, discloses a system wherein a routing coordinator maintains a plurality of connection table records and wherein a plurality of Home Agent Masqueraders (HAMs) and Foreign Agent Masqueraders (FAMs) communicate with the routing coordinator to ensure that client data connections are preserved as the client travels throughout the short-range wireless network environment. Each of the connection table records includes a client address and port, and a server address and port. The system of the present invention can be implemented in combination with the above-identified related invention, where the network control server 103 is co-located with the routing coordinator or, alternatively, where the network adapters 101 are co-located with the HAMs and FAMs. The combined configuration enables clients to preserve network connections as they travel through a short-range wireless network environment and communicate with access points that do not directly support coordination through the routing coordinator.

Accordingly, the network control server 103 of the present invention can be co-located with the core server and/or the routing coordinator of the above-identified commonly-assigned inventions. Moreover, the adapters 101 described in the present invention can be co-located with the HMP and/or the HAM or FAM of these commonly-assigned inventions.

As best depicted in FIG. 2, adapter 101 includes a wireline network interface 200, a wireless network interface 201, network coordination software 202, and an augmented IP stack 203.

Wireline network interface 200 can comprise an Ethernet, token ring or other any other local area network (LAN) known in the art. In the preferred embodiment of the present invention, network adapter 101 incorporates a single wireline network interface 200. However, as will be apparent to those skilled in the art, alternative embodiments of the present invention can include multiple wireline network interfaces, each connecting the adapter 101 to a different LAN.

Wireless network interface 201 can comprise an Ethernet connection, serial cable, RS232 or other cable connection to a wireless access point 100. Preferably, network adapter 101 incorporates a single wireless network interface 201. However, as will be apparent to those skilled in the art, alternative embodiments of the present invention can include multiple wireless network interfaces, each connecting the adapter 101 to a different wireless access point 100.

Network coordination software 202 is provided for communicating with the network control server 103 to provide coordination functions on behalf of the adapted access point 100 within the managed network environment. In the preferred embodiment of the present invention, the network coordination software 202 enables retrieval of network security and quality-of-service policies, retrieval of packet rewriting rules, transmission of logs and alerts, and dissemination of information pertaining to device arrival and departure. Furthermore, the software receives management commands that are forwarded to the access point itself.

Augmented IP stack 203 comprises an IP stack that has been instrumented with particular features to enforce the managed network environment. In the preferred embodiment of the present invention, the aforementioned features include, but are not limited to, packet filtering and packet rewriting. The packet filtering feature prevents a packet from being forwarded to its intended destination, in accordance with the security, quality-of-service or other policies within the managed network environment. The packet rewriting feature rewrites a packet before it is forwarded to an intended destination, in accordance with the policies within the managed network environment. In the preferred embodiment of the present invention, the packet rewriting functions include Network Address Translation (NAT), an address management technique that is well known in the prior art. In one aspect of the present invention, the packet rewriting policies enable a layer 3 (IP) roaming capability.

In an alternate embodiment of the present invention, the augmented IP stack 203 includes support for a mobile IP Foreign Agent (FA). The mobile IP protocol is defined in RFC 2002, available at www.rfc-editor.org. In a further alternate embodiment of the present invention, the augmented IP stack includes services that detect and handle packets corresponding to various standard protocols such as the Domain Name Service (DNS) protocol, Dynamic Host Configuration Protocol (DHCP), Remote Authentication Dial-In User Service (RADIUS) protocol, and Internet Group Management Protocol (IGMP). The augmented IP stack, upon detecting a packet corresponding to one of these services, may filter the packet, forward the packet or generate a response in accordance with the policies within the managed network environment.

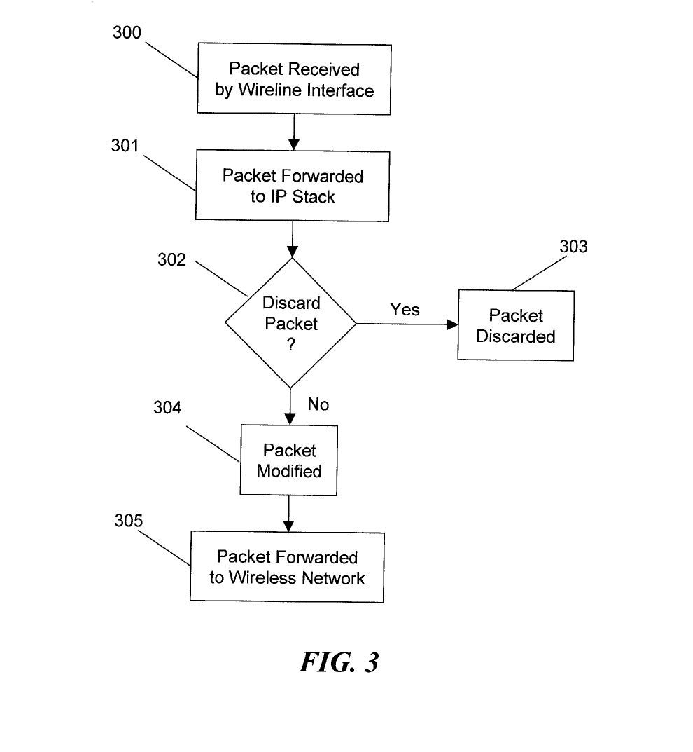

Referring now to FIG. 3, a preferred method of forwarding a packet to the wireless network is illustrated. Upon receipt by wireline interface 300, the packet is forwarded to augmented IP stack 301. Initially, the augmented IP stack 301 determines whether the packet should be discarded 302. If so, the packet is discarded 303 and the processing is completed. If not, the augmented protocol stack determines whether the packet must be modified 304; if so, the packet is modified in accordance with the implementation of the adapter 101. Finally, the packet is forwarded to the wireless network interface for transmission 305. At various points in this process, it may be necessary for the adapter 101 to obtain configuration information from the network control server, in which case the network coordination software in the adapter is invoked to retrieve such information. At various points in this process, the adapter may be required to report information to the network control server, in which case the network coordination software in the adapter is invoked to report the information.

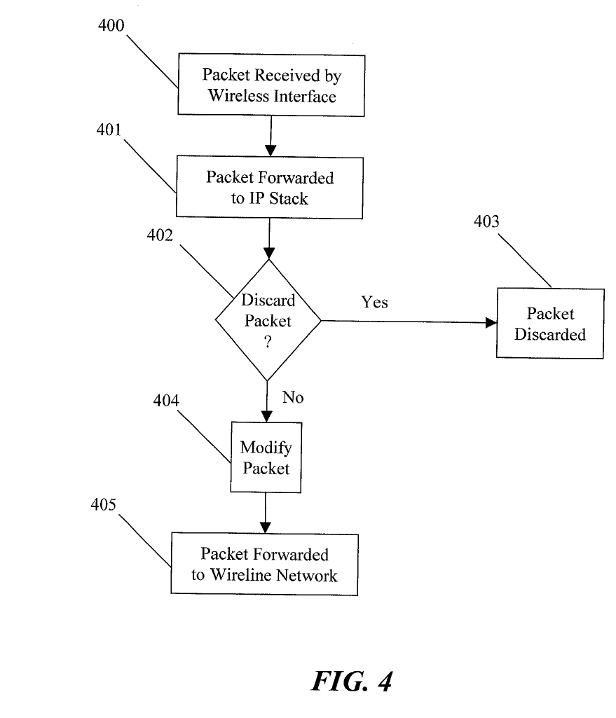

Referring now to FIG. 4, a preferred method of forwarding a packet to the wireline network interface is illustrated. Upon being received by the wireless interface 400, a packet is initially forwarded to augmented IP stack 401. The augmented protocol stack determines whether the packet should be discarded (402) and, if so, the packet is discarded 403 and processing is completed. Where the packet is not to be discarded, the augmented protocol stack determines whether the packet requires modification 404. If modification is required, the packet is modified in accordance with the implementation of the adapter 101. Subsequently, the packet is forwarded to the wireline network interface for transmission 405. At various points in this process, the adapter 101 may require configuration information from the network control server, in which case the network coordination software in the adapter is invoked to retrieve that information. At various points in this process, the adapter may be required to report information to the network control server, in which case the network coordination software in the adapter is invoked to report that information.

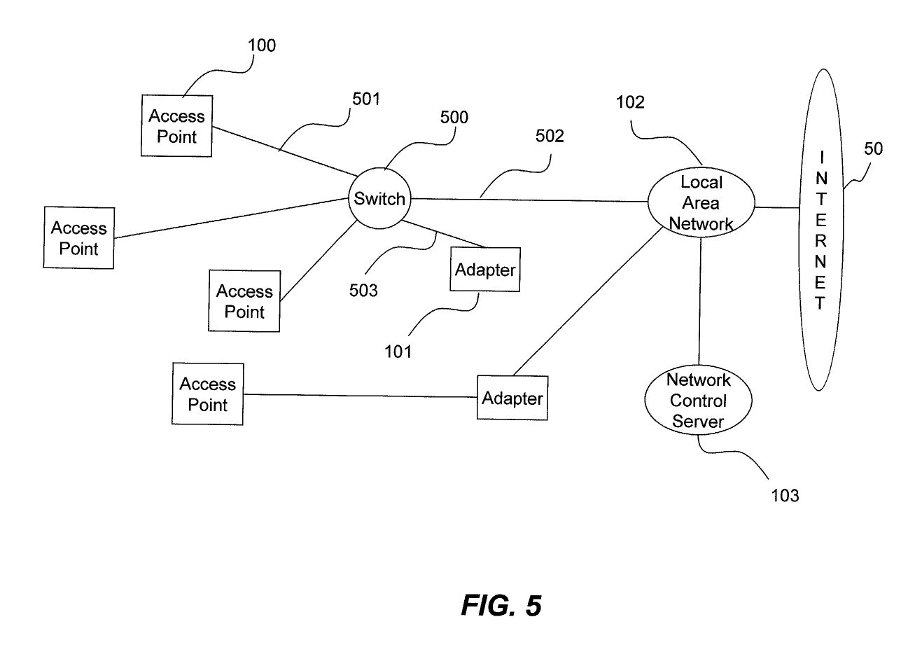

Referring now to FIG. 5, the adapter 101 is illustrated connected to a plurality of access points 100 via a switch 500. In an alternative embodiment of the present invention, adapter 101 provides services to a plurality of short-range wireless access points 100. In this environment, a plurality of short-range wireless access points 100 are individually coupled to switch 500. Although FIG. 5 depicts each access point 100 located on a dedicated segment connected to the switch 500, it will be apparent to those skilled in the art that a single LAN segment can contain multiple wireless access points. Adapter 101 is also attached to switch 500. In this embodiment, the adapter's wireline and wireless interfaces are preferably integrated into a single connection 503 of switch 500. In one implementation of this embodiment, the switch 500 is programmed to automatically forward all inbound packets originating from access point LAN segments 501 to the LAN segment 503 containing the adapter 101. The switch 500 is also programmed to automatically forward all packets not originating from the LAN segment 503 containing the adapter and destined to an access point LAN segment 501, to the LAN segment 503 containing the adapter 101. In this manner, the adapter 101 can receive and process all packets originating from and destined to the access points 100.

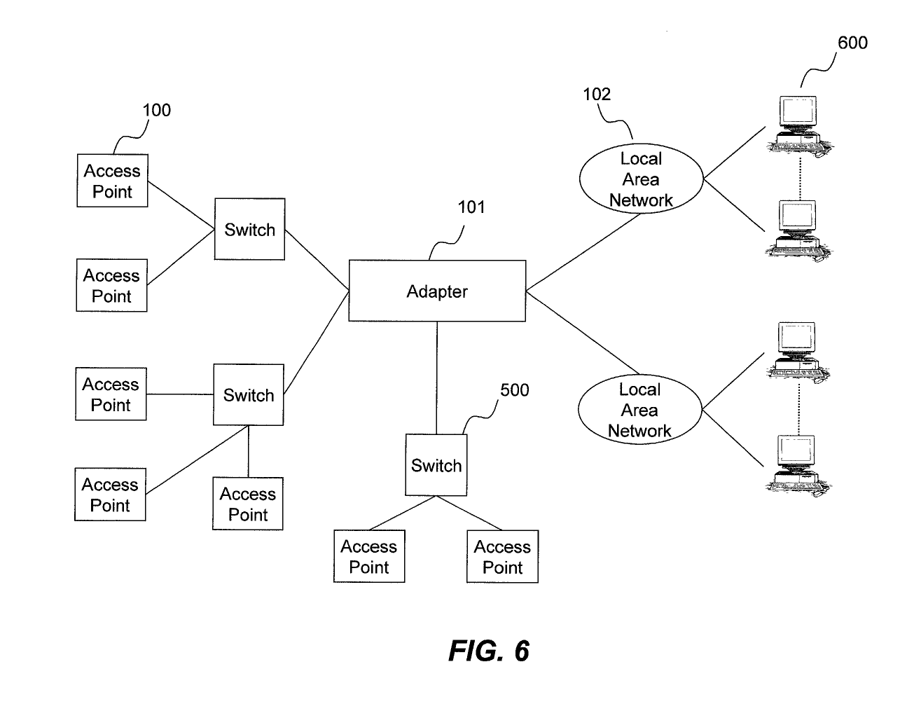

Referring now to FIG. 6, in a further alternate embodiment of the present invention, adapter 101 supports a plurality of switched LANs 102, at least some of which contain wireless access points. In FIG. 6, adapter 101 is shown connected to three switched LANs containing wireless access points. This is merely for illustrative purposes; obviously, the number of LANs and access points can vary.

A plurality of short-range wireless access points 100 provided are coupled to switch 500. There are three access point LANs and the switch 500 of each LAN is connected to the wireless network interface of each adapter 101. The wired network interface of the adapter is connected to a pair of wired LANs 102. One or more personal computers (PCs) 600 are provided connected to each of the wired LANs. In this case, the adapter 101 receives packets sent to or from access points situated in all three switches. Moreover, the adapter is able to process packets sent to or from multiple wired networks.

Although not preferred, the access points 100 of wireless clients may be programmed to forward all wireline-destined packets to the adapter 101 by defining the destination MAC address to be that of the adapter. For example, the access points 100 can be programmed to treat the adapter 101 as a default IP gateway for network traffic. Though this accomplishes the same effect as the first implementation, it is more complex to implement and manage, and therefore less desirable.

In an alternate implementation of this embodiment, the network control server 103 can be co-located with the adapter 101 to reduce the quantity of servers necessarily installed in the network environment, and to reduce the overall system cost.

In a further alternate implementation of the present invention, the components of the network control server can be distributed to provide improved performance or failure handling.

In another implementation of the present invention, the adapter 101 can connect to access points 100 supporting different wireless networks. Furthermore, the aforementioned different wireless networks can incorporate multiple different short-range wireless communication technologies.

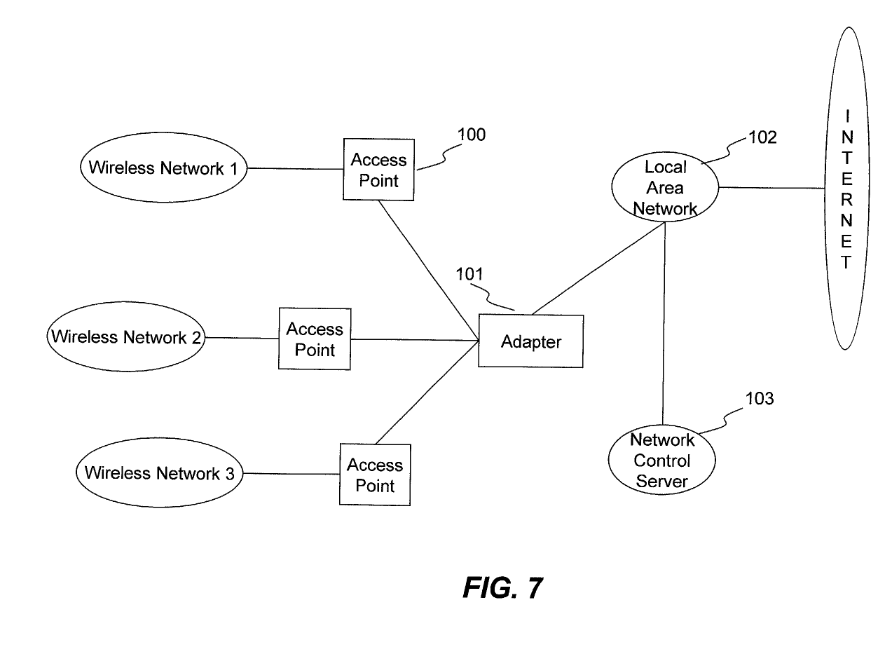

Referring now to FIG. 7, the adapter 101 is illustrated connected to a access points 100 via multiple different wireless networks. These different wireless networks can employ the same network technology, in which case they have distinguished network identifiers, or they can employ different network technologies such as 802.11 and Bluetooth.

Access points 100 from different wireless networks are connected to an adapter wireless network interface. The adapter wired network interface is connected to the wired Local Area Network. It is to be understood that in alternative embodiments, the adapter can be connected to different wireless networks through a plurality of switches, as previously described with respect to FIG. 5 and FIG. 6.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for providing a network adapter for one or more access points in a local area network environment, comprising:
means for connecting said one or more access points to a wired network;
means for connecting said one or more access points to a wireless network;
means for enforcing a managed network environment; and
means for communicating with a network control server.

2. A system as recited in claim 1, wherein said means for connecting to a wired network further comprises a wireline network interface.

3. A system as recited in claim 1, wherein said means for connecting to a wireless network further comprises a wireless network interface.

4. A system as recited in claim 3 wherein said wireless network interface is coupled to a wireless access point.

5. A system as recited in claim 4 wherein said wireless access point further comprises an 802.11 type access point.

6. A system as recited in claim 4 wherein said wireless access point further comprises a Bluetooth-type access point.

7. A system as claimed in claim 3 wherein said wireless network interface is coupled to a Local Area Network (LAN) port.

8. A system as recited in claim 1 wherein said means for enforcing a managed network environment further comprises an augmented IP stack.

9. A system as recited in claim 8 wherein said augmented IP stack includes a Mobile IP Foreign Agent.

10. A system as recited in claim 8 wherein said augmented IP stack detects and handles packets corresponding to a plurality of network services.

11. A system as recited in claim 1 wherein said means for communicating with a plurality of Network Control Servers further comprises a network coordination software.

12. A system as recited in claim 1 wherein said network adapter includes a plurality of wireline network interfaces.

13. A system as recited in claim 1 wherein said network adapter includes a plurality of wireless network interfaces.

14. A system as recited in claim 1 wherein said network adapter is coupled to a switch and said switch is coupled to a plurality of short-range wireless access points.

15. A system as recited in claim 14 wherein said switch is programmable to automatically forward all inbound packets from wireless access point LAN segments to a segment containing said network adapter.

16. A system as recited in claim 14 wherein said switch is programmable to automatically forward all packets not originating from the LAN segment containing the adapter and destined to an access point segment, to the segment containing said network adapter.

17. A system as recited in claim 14 wherein the access points or the wireless clients are programmed to forward all packets to the said network adapter.

18. A system as recited in claim 1 wherein said Network Control Server is co-located with said network adapter.

19. A system as recited in claim 1 wherein said Network Control Server is co-located with a Core Server.

20. A system as recited in claim 1 wherein said Network Control Server is co-located with a Routing Coordinator.

21. A system as recited in claim 1 wherein said network adapter further comprises at least one of a stand-alone personal computer (PC) and a special purpose computing machine.

22. A system as recited in claim 1 wherein said network adapter further comprises software stored within said one or more access points.

23. A system as recited in claim 1 wherein said Network Control Sever is distributed over said network.

24. A system as recited in claim 1 wherein said network adapter is connectable to one or more access points located on a plurality of LAN segments.

25. A system as recited in claim 1 wherein said network adapter is connectable to different wireless LANs.

26. A system as recited in claim 1 wherein said network adapter is co-located with at least one of a Handoff Management Point, a Home Address Masquerader and a Foreign Address Masquerader.

27. A method for providing a network adapter for a plurality of access points in a local area network environment, comprising the steps of:
connecting said access points to a wired network;
connecting said access points to a wireless network;
enforcing a managed network environment; and
communicating with a Network Control Server.

28. A method as recited in claim 27 wherein the step of enforcing a managed network environment further comprises the steps of:
receiving packets from a wireline network;
processing said packets through an augmented IP stack;
determining whether to rewrite said packets; and
forwarding said packets to said wireless network.

29. A method as recited in claim 28, further comprising, prior to the step of forwarding said packets to said wireless network, the step of determining whether to filter said packets.

30. A method as recited in claim 27 wherein the step of enforcing a managed network environment further comprises the steps of:
receiving packets from a wireless network;
processing said packets through an augmented IP stack; and
forwarding said packets to a wireline network.

31. A method as recited in claim 30, wherein said step of processing further comprises, prior to the step of forwarding, the steps of:
determining whether to filter said packets; and
determining whether to rewrite said packets.

32. A method as recited in claim 31, further comprising the steps of:
detecting packets corresponding to a plurality of network services via said augmented IP stack; and
handling said packets.

33. A method as recited in claim 27, further comprising the step of determining an access point currently associated with a mobile client by inspecting a MAC address associated with packets transmitted by a mobile client.
